(19) United States
(12) Patent Application Publication
(10) Pub. No.: US 2002/0035544 A1
(43) Pub. Date: Mar. 21, 2002

(54) Method and apparatus for forming content, method and apparatus for reproducing content and computer readable storage medium

(76) Inventors: Satoru Wakao, Tokyo (JP); Nobuhiro Tagashira, Kanagawa (JP); Yuji Suga, Kanagawa (JP)

Correspondence Address: Joseph A. Calvaruso, Esq., Morgan & Finnegan, L.L.P., 345 Park Avenue, New York, NY, 10154-0053, US

(21) Appl. No.: 09/947,019

(22) Filed: Sep. 5, 2001

(30) Foreign Application Priority Data
Sep. 6, 2000 (JP) 270409/2000

(51) Int. Cl. G06F 17/60

(52) U.S. Cl. 705/51

(57) ABSTRACT

A method for creating content in a multi-media encoding system and provided with an intellectual property rights protection and management system, in which intellectual property rights protection and management information containing verification data for verifying the authenticity of information in the content is generated, and the intellectual property rights protection and management information is buried into the content in the form of a message used by the intellectual property rights protection and management system.

### BACKGROUND OF THE INVENTION

1. Field of the Invention

The present invention relates to a method and an apparatus for creating content, a method and an apparatus for reproducing content and a computer readable storage medium, which comply with a multi-media encoding system and are equipped with an intellectual property, e.g., copyright, protection management system.

2. Related Background Art

In recent years, MPEG-4 (Moving Picture Expert Group phase 4) has become the ISO (International Organization for Standardization) standard as a method for encoding motion images, audio and other data, handling each of these kinds of encoded data as objects, compositing these multi-media data and transmitting them as a single bit stream.

On the receiving side, where this multi-media data encoded as MPEG-4 data is received (i.e., on the reproduction side), the audio and the motion image scene or the like are linked together and regenerated. This type of MPEG-4 system is characterized by handling the data as objects, and this enables the received bit stream to be readily deconstructed into individual bits of each object and enables the deconstructed bits to be reassembled easily.

An MPEG-4 data stream such as the one described above is different from multi-media streams which were common until now, in that the MPEG-4 has a function of sending and receiving several motion image scenes and motion image objects independently on a single stream. Further, with respective to audio, too, the MPEG-4 has a function of sending and receiving several objects independently on a single stream.

BIFS (Binary Format for Scenes), which is created by modifying VRML (Virtual Reality Modeling Language), exists as information for compositing these objects and compositing a scene. In this BIFS, a scene is written in binary values, so the scene is composited according to this BIFS.

These types of individual objects which are necessary for compositing the scene are encoded individually in an optimal fashion before being sent, so they are decoded individually on the decoding side and a time axis in each of the individual sets of data is synchronized to a time axis of a reproducing apparatus according to BIFS, and the scene is composited and outputted.

FIG. 1 is a block diagram depicting a schematic construction of a common MPEG-4 reproducing apparatus.

In FIG. 1, a transmission path 101 is a data path such as a variety of types of networks, computer busses, etc., into which the MPEG-4 stream is inputted. Here, the transmission path means not only the communications path, but also interfaces between storage media apparatuses such as CD-ROM, DVD-ROM and DVD-RAM and reproducing apparatuses.

At the reproducing apparatus the MPEG-4 stream, which is distributed from the network and the storage media apparatuses, is inputted into a demultiplexing unit 102. Here, the MPEG-4 stream is separated into scene description information, motion image object data, audio object data, object descriptors and other elements, and then those are inputted into the corresponding memory units 103 to 106 respectively.

Here, the audio object data is data which has been encoded with, for example, the commonly known CELP (Code Excited Linear Prediction) encoding or TWINVQ (Transform domain Weighted Interleave Vector Quantization) encoding, or some other such high-efficiency encoding; and the motion image object data is data which has undergone high-efficiency encoding in MPEG-4 or H-263 system.

Further, the object descriptors are data which include control information relevant for reproducing and attribute information relevant to each of the objects.

Sets of object data in the memory units 104 to 106 are inputted into the decoding units 108 to 110 respectively. The decoding units 108 to 110 decode the information mentioned above, which has been encoded according to the high-efficiency encoding, such as the motion image object data, the audio object data and the object data descriptors mentioned above and other such information. However, the scene description information, which information has been inputted into the memory unit 103, is the only information which is directly inputted into the scene description decoding unit 107 and then decoded.

Note, however, FIG. 1 assumes an apparatus which is capable of decoding even when the MPEG-4 stream contains plural and mutually different types of objects as to each of audio object, motion image object and object data descriptor; therefore, a plural number of sets of memory units 104 to 106 and the decoding units 108 to 110 must be provided for the audio, for the motion image and for the object descriptor.

Then the audio object, the motion image object and the object descriptor which were each decoded at the decoding units 108 to 110 are composited and undergo graphic processing at a composition unit 112 based on the scene description information decoded at the scene description decoding unit 107. The data which is finally obtained in this way is provided to an output apparatus 113 such as a display or printer apparatus and thus becomes viewable.

Here, in the case when it is necessary, for purposes of protecting copyrights or the like, to perform controls to execute or to suspend reproduction of the individual object data which make up the audio or motion image scene or the like, an IPMP (Intellectual Property Management and Protection) system is used to perform these controls.

An IPMP control unit 111 cuts off the stream at a control point as necessary based on an IPMP descriptor from the demultiplexing unit 102, or accesses the decoding units 108 to 110 and instructs to stop the decoding operations. The word “descriptor” here means an aggregate of data for describing the control information which is necessary at the time when the reproducing apparatus regenerates the data, and the IPMP descriptor is a descriptor which is provided to describe information pertinent to controls for the reproduction of the object data.

Accordingly, in the case when the IPMP control unit 111 makes a determination based on the data in the IPMP descriptor that there is no justifying right to view or listen to the data, this data is not decoded; and accordingly, the reproduction is not performed. Performing such the control protects data which is copyrighted.

The IPMP information is important information relevant to the reproduction and control of data which has been received. In other words, there is a possibility that an ill-willed person who does not have permission to view or listen to the received data may perform some sort of unauthorized alteration on this IPMP data in order to view or listen to the received data illegitimately.

If there is an intellectual property rights protection system which includes prevention of illegitimate actions, then the owner of the copyright on the content can feel safe providing content; however, if that system is incomplete then he or she may become hesitant to provide content.

That is, in order to establish a business involving a content distribution service using a network, it is necessary to protect and manage the IPMP system data, which IPMP system is the intellectual property rights protection and management system used in the MPEG-4 standard, so that only legitimate subscribers can view or listen to received data. Nevertheless, at the present time no means has been set up for protecting IPMP data.

### SUMMARY OF THE INVENTION

In view of the above, an object of the present invention is to provide a method and an apparatus for creating content, a method and an apparatus for reproducing content and a computer readable storage medium in a multi-media format, which apparatus and method can attain improved security function for protecting information in the content in an encoding system provided with an intellectual property rights protection and management system.

According to a preferred embodiment of the present invention, there is provided a method for creating content in a multi-media encoding system provided with an intellectual property rights protection and management system, comprising the steps of generating intellectual property rights protection and management information containing verification data for verifying the authenticity of information in the content, and burying the intellectual property rights protection and management information into the content in the form of a message used by the intellectual property rights protection and management system.

According to an another preferred embodiment of the present invention, there is provided a computer readable storage medium on which is recorded a program for executing the method for creating content method in a multi-media encoding system provided with an intellectual property rights protection and management system, the program comprising a code for generation step of generating intellectual property rights protection and management information containing verification data for verifying the authenticity of information in the content; and a code for multiplexing step of burying the intellectual property rights protection and management information into the content in the form of a message used by the intellectual property rights protection and management system.

According to an another preferred embodiment of the present invention, there is provided an apparatus for creating content in a multi-media encoding system provided with an intellectual property rights protection and management system, comprising a generating device arranged to generate intellectual property rights protection and management information containing verification data for verifying the authenticity of information in the content; and a multiplexer arranged to bury the intellectual property rights protection and management information into the content in the form of a message used by the intellectual property rights protection and management system.

According to an another preferred embodiment of the present invention, there is provided a method for reproducing content in a multi-media encoding system provided with an intellectual property rights protection and management system, comprising the steps of inputting a content in which intellectual property rights protection and management information containing verification data for verifying the authenticity of information in the content is buried, detecting the intellectual property rights protection and management information in the content, and controlling the reproducing operation of the content based on the detecting result.

According to an another preferred embodiment of the present invention, there is provided a computer readable storage medium on which is recorded a program for executing the method for reproducing content in a multi-media encoding system provided with an intellectual property rights protection and management system, the program comprising a code for an inputting step of inputting a content in which intellectual property rights protection and management information containing verification data for verifying the authenticity of information in the content is buried, a code for a detection step of detecting the intellectual property rights protection and management information in the content, and a code for a controlling step of controlling a reproducing operation of the content based on the detecting result of the detecting step.

According to an another preferred embodiment of the present invention, there is provided an apparatus for reproducing content in a multi-media encoding system provided with an intellectual property rights protection and management system, comprising an inputting device arranged to input a content in which intellectual property rights protection and management information containing verification data for verifying the authenticity of information in the content is buried, a detector arranged to detect the intellectual property rights protection and management information, and a controller arranged to control the reproducing operation of the content based on the detecting result of the detector.

Other objects, features and advantages of the invention will become apparent from the following detailed description taken in conjunction with the accompanying drawings.

### BRIEF DESCRIPTION OF THE DRAWINGS

FIG. 1 is a block diagram depicting a schematic construction of a common MPEG-4 reproducing apparatus;

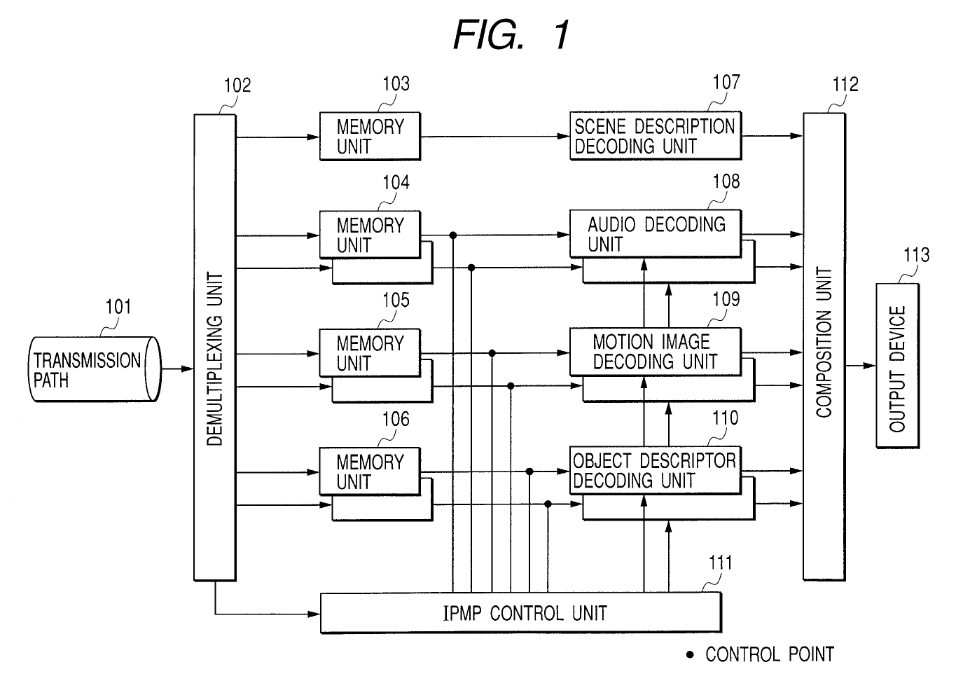

FIG. 2 is a block diagram depicting a schematic construction of a transmission apparatus in an embodiment according to the present invention;

FIG. 3 is a diagram depicting a construction of an MPEG-4 stream in an embodiment according to the present invention;

FIG. 4 is a diagram depicting a construction of permission data in an embodiment according to the present invention;

FIG. 5 is a diagram depicting an IPMP descriptor structure in an embodiment according to the present invention;

FIG. 6 is a diagram depicting a construction of a signature descriptor in an embodiment according to the present invention;

FIG. 7 is a block diagram depicting a schematic construction of a reproducing apparatus in an embodiment according to the present invention;

FIG. 8 is a flow chart for explaining an operation of the transmission apparatus in an embodiment according to the present invention; and

FIG. 9 is a flow chart for explaining an operation of the reproducing apparatus in an embodiment according to the present invention.

### DETAILED DESCRIPTION OF THE PREFERRED EMBODIMENTS

Hereinafter, explanation will be made of an embodiment of the present invention, making reference to the drawings.

First, explanation will be made of a data distribution system comprised of a transmission apparatus and a reproducing apparatus, a method for generating data and a data structure. Next, explanation will be made of one example of an operation of the transmission apparatus and one example of an operation of the reproducing apparatus in the data distribution system, with each of the explanations being made based on flow charts.

First, explanation will be made of the transmission apparatus and a sequence up to a point where an MPEG-4 stream are generated.

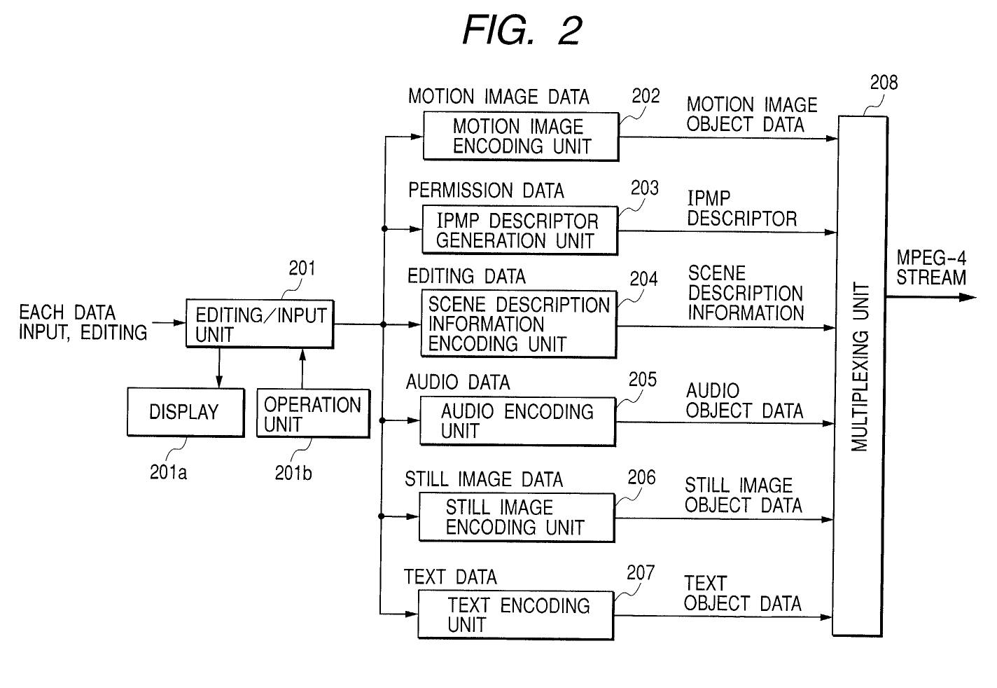

FIG. 2 is a block diagram depicting a schematic construction of the transmission apparatus of an embodiment according to the present invention.

In FIG. 2, motion image data inputted into an editing/input unit 201 is encoded at a motion image encoding unit 202 according to an encoding system such as MPEG-4 or H-263 and converted into motion image object data. At an audio encoding unit 205 audio data is encoded and converted into audio object data. Still image data is compressed at a still image encoding unit 206 according to a system such as JPEG and converted into still image object data, and text data is converted into text object data at a text encoding unit 207.

Further, scene description information is required at the reproducing apparatus, which is information for designating how these object data are to be composited and on which timing the object data should be reproduced. This scene description information is generated when a scene description information encoding unit 204 processes editing data, which was generated by an editing procedure at the editing/input unit 201 performed by an editor.

Additionally, at the reproducing apparatus an IPMP descriptor is generated, which is control information for performing such controls as executing reproduction of or suspending reproduction of the individual object data for purposes of protecting intellectual property rights (i.e., copyrights). This IPMP descriptor is generated when an IPMP descriptor generation unit 203 processes permission data, which was generated by the editor performing an editing procedure using the editing/input unit 201.

At a multiplexing unit 208 the motion image object data, the audio object data, the still image object data, the text object data, the IPMP descriptor and the scene description information are multiplexed and an MPEG-4 stream is generated.

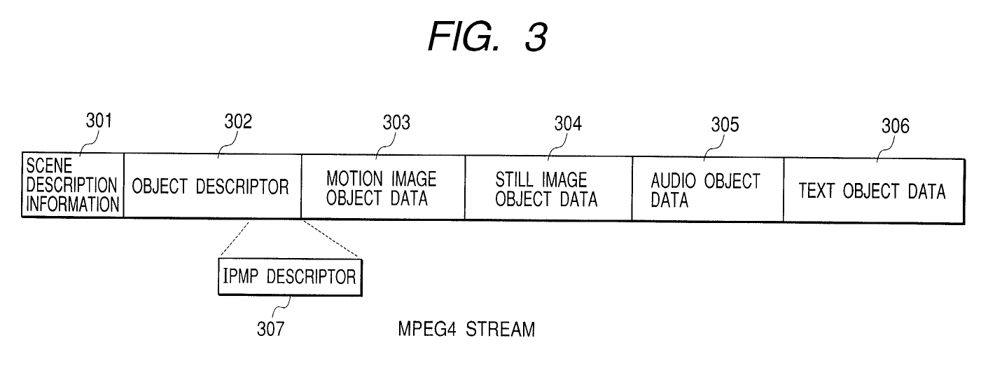

As shown in FIG. 3, the MPEG-4 stream is comprised of the scene description information 301, the motion image object data 303, the still image object data 304, the audio object data 305, the text object data 306 and the object descriptor 302 which is the control information for the object data.

Further, one constitutive element of the object descriptor 302 is the IPMP descriptor 307. Therefore, the IPMP descriptor 307 is transmitted as one constitutive element of the object descriptor 302.

Hereinafter, explanation will be made of one method for generating the IPMP descriptor.

In the present embodiment, the editor uses the IPMP system to perform viewing and listening control of the motion image data. Therefore, the editor performs an input procedure at the editing/input unit 201 regarding to which part or parts of the motion image the IPMP system should apply the listening and viewing limitation. In the present embodiment, frames are used as the unit for designating limitations on the listening to and viewing of the motion image data; however, this unit is not limited to the frame, and it may be a predetermined amount of data which is to be treated as one unit.

In the present embodiment, it becomes necessary to count the frames which comprise the motion image data. Here, one frame is a unit capable of constituting one picture image only by the data contained in one frame (i.e., the motion image is comprised of a group of several picture images).

The count of the number of frames may be calculated from information in the header of the motion image data and the amount of motion image data. After the counting is finished, the frames which comprise the inputted motion image data are displayed with a frame number on a frame basis on the display 201a connected to the editing/input unit 201. The editor decides to which frames the listening and viewing limitation should be applied while viewing the display 201, and inputs information for the viewing/listening limitation into the editing/input unit 201 by means of a keyboard or other such operation unit 201b based on the decisions.

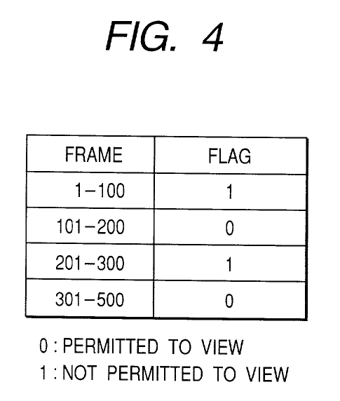

Inputting the information for the viewing/listening limitation causes the editing/input unit 201 to generate the permission data as shown in FIG. 4.

In FIG. 4 depicts data generated when the user applies the viewing/listening limitations to the series of frames from frame 1 to 100 and from frame 201 to 300, and does not apply the viewing/listening limitation to the other frames. According to the present embodiment, the total number of frames is 500 and a flag of “1” is set on the range of frames on which the viewing/listening limitation has been applied, and a “0” is set on the other frames.

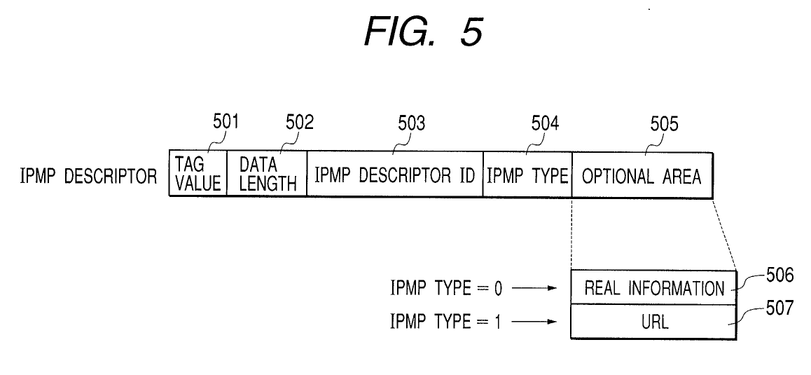

The permission data mentioned above is transmitted to the IPMP descriptor generation unit 203 and is stored in a real information area 506 shown in FIG. 5.

Here, explanation will now be made of an IPMP descriptor structure based on FIG. 5.

A tag value 501 in the IPMP descriptor 307 is data indicating the beginning of that IPMP descriptor 307, and in a data length 502 there is written data which pertains to the data length of the IPMP descriptor 307.

An IPMP descriptor ID 503 is ID information for distinguishing between IPMP descriptors in a case of that a plurality of IPMP descriptors exist, and an IPMP type 504 is data indicating what kind of data is present in the subsequent optional area. In a case of that the value stored in the IPMP type 504 area is “0”, the real information 506 is present in the optional area 505, and in a case of that the value stored in the IPMP type 504 area is “1”, then URL information 507 is present in the optional area 505.

As described above, the IPMP data is important data relevant to the viewing/listening limitations on the object data. Therefore, it is predictable that a person trying to attack the system and view or listen to data illegitimately would first alter this IPMP descriptor.

Therefore, in order to deal with an attack on the IPMP system, digital signature data for verifying the legitimacy of the IPMP descriptor is added to the real information area of the IPMP descriptor. The IPMP descriptor structure explained above is determined according to MPEG-4 specifications, and it is necessary to follow the above specifications in order to comply with “MPEG-4 standard”. However, at present there is no limit in terms of specifications on the method used for describing the real information data. Therefore, adding the IPMP descriptor digital signature data to the real information area does not violate the specifications.

Here explanation will be made of the digital signature data.

The digital signature is used in such a manner that a sender transmits data and signature data corresponding to that data and a receiver verifies the signature data and confirm the legitimacy of the data. The definition of a digital signature (i.e., an electronic signature) according to the “A draft law concerning electronic signatures and certification services” is “A measure taken with regard to information which can be recorded in an electromagnetic record, and to which both of the following requirements apply:

1. The measure indicates that the information was created by the person who performed the measure; and

2. The measure can confirm whether or not any alteration of the information has been performed.”

One digital signature which fulfills the above definition can be realized by using an public key encryption and a hush function. This method is explained hereinafter.

First, explanation will be made of the public key encryption.

Public key encryption is an encryption method in which the encoding key and decoding key are different, and the encoding key is publicly disclosed while the decoding key is held secretly.

Characteristics of public key encryption are:

(a) The encoding key and the decoding key are different, and the encoding key is publicly disclosed, so it is not necessary to send the encoding key in a secret fashion, and thus key sending becomes easier.

(b) Each of the users' encoding keys are publicly disclosed, so the users only have to store secretly their own decoding keys.

(c) It is possible to achieve a verification function in order for the receiver to be able to confirm that the sender of the text which has been sent is not a false person and that the text has not been altered.

For example, assuming that the encoding operation using the public encoding key Kp on plain text data M is E(Kp,M), and the decoding operation using the secret decoding key Ks is D(Ks,M). In such a case, the public key encryption algorithm satisfies the following two conditions:

(1) When Kp is given, the calculation E(Kp,M) is easy to perform. When Ks is given, the calculation D(Ks,M) is easy to perform.

(2) If Ks is not known, the volume of calculations necessary to determine M is great and poses difficulties, even if the calculation sequence of Kp and E and the equation C=E(Kp,M) are known.

Next, in addition to (1) and (2) above, when the following condition (3) is met then secret communication can be achieved:

(3) E(Kp, M) can be defined for all of the plain text M, and D(Ks,E(Kp,M))=M is satisfied.

That is, since Kp is publicly disclosed anyone is capable of calculating E(Kp,M); however, only the person with the private key Ks can calculate D(Ks,E(Kp,M)) to obtain M. At the same time, when following condition (4) is satisfied in addition to (1) and (2) above, then verification is achieved:

(4) D(Ks,M) can be defined for all of the plain text M, and E(Kp,D(Ks,M))=M is satisfied.

That is, only the person who has the private key Ks is able to calculate D(Ks,M), and even if another person uses a false private key Ks′ to calculate D(Ks′,M) in order to pose as the person who posses Ks, E(Kp,D(Ks′,M))≠M is satisfied, so the receiver is able to confirm that the received information is illegitimate. Further, even if D(Ks,M) is altered, this also results in E(Kp,D(Ks,M)′)≠M, so the receiver is able to confirm that the received information is illegitimate.

Rsa encryption, R encryption, W encryption and others are known as representative examples of methods capable of conducting the secret communications and verification communications mentioned above. Encoding and decoding according to RSA encryption, which is the most widely used at present, are depicted in the following fashion:

Encoding:

encoding key (e,n)

encoding conversion C=M^{e}(mod n)

Decoding:

decoding key (d,n)

decoding conversion M=C^{d}(mod n)

n=p·q (here, p and q are mutually different, large prime numbers)

There exist the following methods which use the above-described public key encryption for generating and verifying digital signature data for the confirmation of the legitimacy of the data.

The sender of the data performs the calculation D(Ks,M) on the sending data M using the private key Ks which the sender possesses him or herself and produces the digital signature data s. Then the sender sends the digital signature data s and the plain text data M to the receiver.

The receiver performs a calculation E(Kp,s) on the received digital signature data s using the sender's public key Kp, and compares the calculation results M′ with the received data M. In the case when the comparison reveals that M and M′ are the same, it is confirmed that the received digital signature data s have been subjected to calculation processing using the private key Ks of the sender.

The private key Ks of the sender is information which only the sender knows; therefore, 1) if the receiver can verify that the signature data was created by the sender and if the data matches, then 2) the receiver can verify that the sent data M has not been altered.

In public key encryption, exponentiation and residue calculations are necessary both for encoding and for decoding; therefore, the amount of calculations to be performed is much greater than that in the case when encryption is performed using a common key, and so high speed processing is difficult. Therefore, it is not generally common to perform the public key encryption calculations directly on the sent data M. Rather, the public key calculations are performed after the data has been compressed to a given size, and then the calculations are performed on this compressed data.

A hush function is used for this compression. This hush function H( ) has a function such that plain text data M of an optionally determined length is processed and this produces an output H(M)=h, which is of a given length. Here, this output h is referred to as the hush value (or the message digest, or digital fingerprint) of the plain text data M.

What is required of the hush function is that it is one-directional and is collision resistant. One-directional means that when h is given, the calculation of the plain text data M, which is h=H(M), is difficult because of the amount of calculations needed to be made. Collision resistant means that when the plain text data M is given, the calculation of a plain text M′(M≠M′), which satisfies H(M)=H(M′), and the calculation of plain text data M and M′, which satisfies H(M)=H(M′) and M(M≠M′) are difficult because of the amount of calculations needed to be made.

Examples of known hush functions are MD-2, MD-4, MD-5, SHA-1, RIPEMD-128, RIPEMD-160, and others. The algorithms for these have been publicly disclosed.

In the case when this hush function is used in addition to the public key encryption, the generation and the verification of the digital signature data, which is for the data authenticity confirmation, is as follows.

The plain text data M is compressed by means of the hush function, and a calculation of an output h having a given length is performed. Next, a calculation D(Ks,h)=s is performed using the sender's private key Ks to covert h and create the digital signature data s. After that the digital signature data s and the plain text data M are sent.

On the other hand, the receiver performs a calculation E(Kp,s′)=h′ to convert the received digital signature data s' with the public key Kp, and a calculation using the same hush function as the sender's to compress the received plain text data M′ and produce h″, and if h′ and h″ match each other then the received data M′ is judged to be legitimate.

In the case when the plain text data M has been altered somewhere between sending and receiving, then E(Kp,s)=h′ does not match with h″, which is the received plain text data M′ compressed by the same hush function as the sender's, so the alteration has been detected. Here, when the digital signature data s has also been altered together with the plain text data M, the alteration can no longer be detected. However, in order to do this it is necessary to obtain the plain text data M from h, and a calculation such as this is not possible due to the one-directionality of the hush function.

Therefore, adding the digital signature data into the IPMP descriptor produces a result that when the data inside the IPMP descriptor is altered during the MPEG-4 data transmission, the alteration is discovered when the digital signature data is checked at the reproducing apparatus, and the data reproduction can be stopped. That is, the copyright protection for the object data is strengthened.

Therefore, the data which is comprised of the digital signature data described above is added as “signature descriptor” being a kind of control information to real information area of the IPMP descriptor.

Hereinafter, explanation will now be made of the generation of the signature descriptor and the digital signature data.

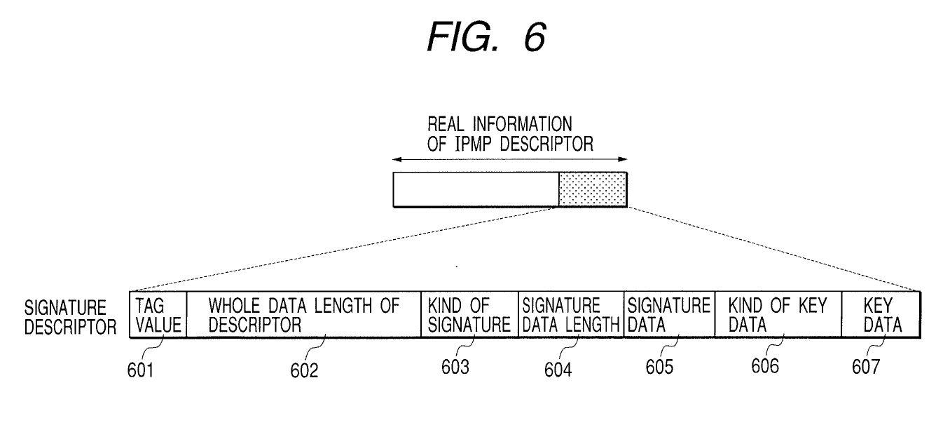

First, explanation will be made of one example of a structure for the signature descriptor based on FIG. 6.

In FIG. 6, a tag value 601 is data which indicates that the signature descriptor begins, and at whole data length of descriptor 602 data is written as data regarding the data length of the signature descriptor.

Next, a kind of signature 603 is described, indicating which hush function and which public key encryption algorithm were used to generate the signature data. Data relating to the data length of the signature data is described at a signature data length 604. At a signature data 605, the generated signature data itself is described. At a kind of key data 606, the kind of the key data written in the next area is written.

At a key data 607 there is written data which is to be used for the verification of the signature data performed by the reproducing apparatus, and in the case when the digital signature data was generated by means of public key encryption, then in this area there is written the public key Kp corresponding to the private key Ks which was used. At this time, data indicating the public key that is described in the kind of key data 606.

Further, in a case when the data (i.e., the key data) necessary for the verification for the digital signature data is publicly disclosed at a URL and the reproducing apparatus accesses the URL before verifying the signature data, data indicating URL is written in the kind of key data 606, and the actual URL address is written in the key data 607.

Next, explanation will now be made of the generation of the digital signature data.

The IPMP descriptor generation unit 203 generates the digital signature data of all of the data units other than the signature descriptor for the IPMP descriptor and stores these in signature data 605. In other words, according to the present embodiment, calculations using the hush function H( ) are performed on the IPMP descriptor tag value, data length, IPMP descriptor ID, IPMP type and all of the data D for the approval information, and then the hush value h=H(D) which is produced by these calculations undergoes calculations using the transmission apparatus's private key Ks to generate the digital signature data S=D(Ks,h).

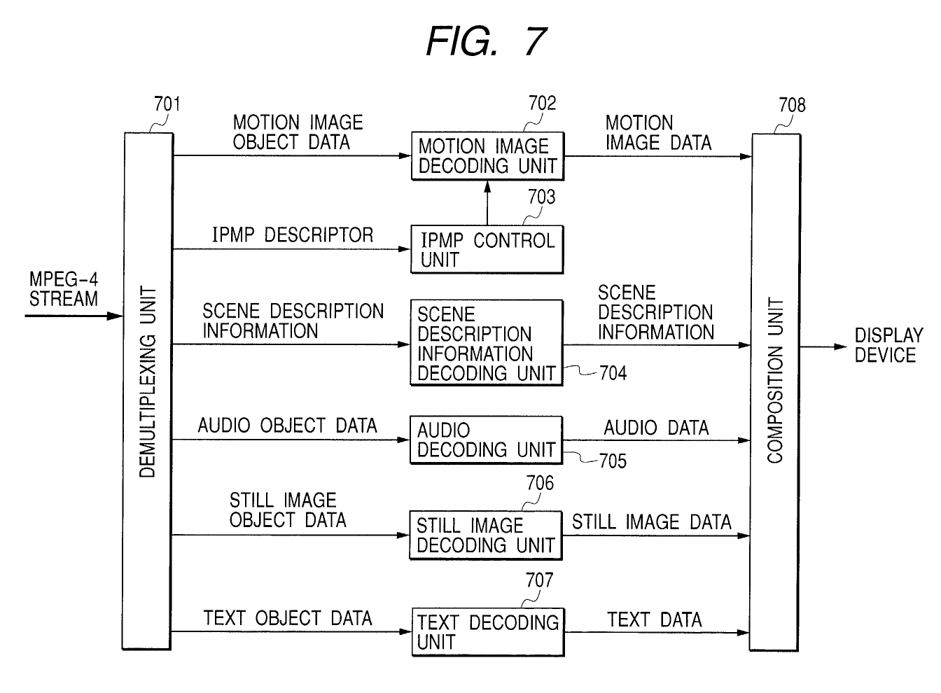

Next, using FIG. 7, explanation will be made of one example of a reproducing apparatus for reproducing the MPEG-4 stream which was generated as described above.

FIG. 7 is a block diagram depicting a construction of a reproducing apparatus.

Explanation will first be made of sequence in FIG. 7 from a point where the MPEG-4 stream is inputted to a point where it is displayed on the display apparatus.

The inputted MPEG-4 stream is separated at a demultiplexing unit 701 into the motion image object data, the IPMP descriptor, the scene description information, the audio object data, the still image data and the text object data, and these are each inputted into their respective decoding units 702 to 707. Each of these decoding units have internal memories, and each of object data is processed after being stored in these memories.

At each of these decoding units, each of object data is decoded according to decoding time information in the headers of each of object data, and motion image object data, scene description information, audio object data, still image data and text object data are generated.

At the composition unit 708 these data are composited according to synthesis time information and the scene description information in the header of each of object data, and then are displayed on a display apparatus.

Next, explanation will now be made of the viewing/listening controls on the moving image object data, and the verification of the digital signature data.

The IPMP control unit 703 extracts the permission data from the IPMP descriptor which has been transmitted. This permission data is data which has been generated at the editing/input unit of the transmission apparatus. At the IPMP control unit 703, control of the motion image decoding unit 702 is performed in accordance with the permission data. According to the present embodiment, the viewing/listening limitation has been applied to the frames 1 to 100 as shown in FIG. 4, so a control is performed on the motion image decoding unit 702 such that it does not output the decoded data of the frames 1 to 100 to the composition unit 708. Therefore, the motion image data cannot be composited at the composition unit 708, so the motion image is not displayed.

In contrast, listening to and viewing of the frames from 101 to 200 is approved; therefore, a control is performed to the motion image decoding unit such that it outputs the decoded data of the frames 101 to 200 to the composition unit 708. Therefore, the motion image data is composited at the composition unit and the motion image is displayed.

Subsequently, the IPMP control unit 703 performs controls on the motion image decoder unit 702 in the same way such that the data of the frames for which viewing and listening is being limited is not outputted to the composition unit 708, and the data of frames for which viewing and listening has been approved is outputted to the composition unit 708. In this way, it becomes possible to achieve viewing/listening control on the motion image data in accordance with the intention of the editor.

Hereinafter, explanation will now be made of IPMP descriptor verification procedures performed by the reproducing apparatus before performing the control procedures described above.

The IPMP control unit 703 uses the tag value to identify the signature descriptor in the IPMP descriptor. Then it extracts the signature data S′ from this signature data. Further, in the case when the digital signature data was generated at the transmission apparatus according to a public key encryption system, the public key Kp which corresponds to the private key Ks used for the encoding is written in the key data, so the IPMP control unit 703 extracts this public key Kp from this key data and uses this public key Kp to process the extracted signature data S′ and produce h′=E(Kp,S′).

Further, in the case when the data (i.e., the key data) which is necessary for the verification is disclosed publicly at a URL the address of this URL is written in the key data, so the IPMP control unit 703 accesses this URL and obtains the data which is necessary for the verification before performing the calculations mentioned above.

Meanwhile, the calculations which use the hush function are performed on all the data other than the signature descriptor in the IPMP descriptor. That is, according to the present embodiment, the calculations are performed using the hush function H( ) on all data of the IPMP descriptor tag value, data length, IPMP descriptor ID, IPMP type and the data D′ of the approval information. Then the result h″=H(D′) from the hush function calculations and the result h′ from the calculations performed on the signature data by means of the public key Kp are compared.

As a result of this comparison, in the case when the results of the two calculations match (i.e., h′=h″), it is determined that the IPMP descriptor has not been altered, so the viewing/listening control based on the approval information is performed.

On the other hand, in the case when the results of the two calculations do not match, then the IPMP descriptor is considered to have been altered. Therefore, the IPMP control unit 703 performs controls on the motion image decoding unit 702 such that the unit 702 does not perform any decoding operations at all, and also provides instructions to the composition unit 708 to display a message on a screen indicating that the alteration has been detected. Displaying such the message enables the receiver to know whether the reason why he or she cannot perform the reproduction is that a contract has not been formed or that the data has suffered some sort of alteration.

According to the above embodiment, the data indicating the kind of signature is used to detect what kind of hush function and what kind of public key encryption system were used to generate the signature data, and the above calculations are performed using the same function and public key encryption system as the hush function and the public key encryption used for the creation of the signature data.

According to the above method, it is possible to discover an alteration in the case when an alteration has been made to the IPMP data, which is important data for the reproduction controls; therefore, it is possible to defend the system from an attack by an ill-intentioned person. Therefore, it becomes possible for only a person who has a legitimate viewing/listening right to view/listen to the data, and the holder of the copyright on the content can feel safe in providing the content, so a business can be established involving a content distribution service using a network.

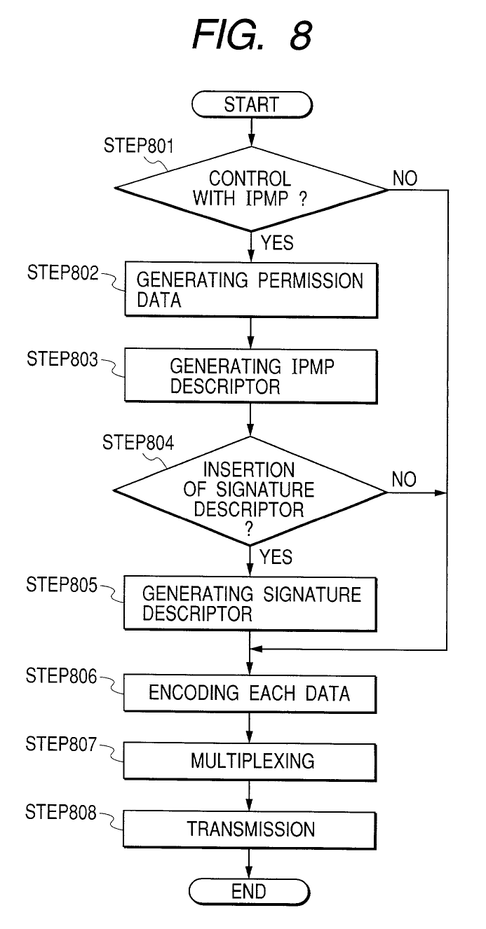

Hereinafter, explanation will be made using a flow chart depicted in FIG. 8 of an operation of an apparatus of the present invention, and in particular one example of processing performed by the transmission apparatus.

FIG. 8 is a flow chart for explaining processing which is performed when the transmission apparatus generates the MPEG-4 stream. Note that in the present embodiment, the digital signature data is generated according to a public key encryption system.

In FIG. 8, at step 801 a determination is made as to whether an input has been made for the editor to use the IPMP system to perform viewing/listening control on the object data. In the case when the input indicating that the viewing/listening control is performed with the IPMP system is made, the process advances to step 802, and in the case when the input has not been performed the process advances to step 806.

Next, at step 802 the permission data is generated based on the inputted viewing/listening control data, and the process advances to step 803.

At step 803 the IPMP descriptor is generated by writing the data which indicates the beginning of the IPMP descriptor, into the tag value 501, writing serial numbers for distinguishing the various IPMP descriptors into the IPMP descriptor ID 503, writing the “0” into the IPMP type 504 since real information is written in the optional area 505 following thereafter, writing the approval information generated as described above into the real information 506 and writing the data length of the IPMP descriptor into the data length 502 (see FIG. 5).

At the next step 804, a determination is made as to whether or not an input will be made for inserting the signature descriptor, which is comprised of the digital signature data and other data which are used for verification, into the IPMP descriptor. This input is one which is performed by the editor, too. In the case when the input to insert the signature descriptor has been performed the process advances to step 805, and in the case when this input has not been made the process advances to step 806.

At step 805 the calculation H(D)=h using the hush function Ho is performed on the tag value, the data length, the IPMP descriptor ID, the IPMP type, and the all data D of the approval information in the IPMP descriptor.

Calculations using the transmission apparatus's private key Ks are performed on the hush value h resulting from the above calculations to generate the digital signature data s=E(Ks,h), and the digital signature data is written into the signature data 605 of the digital signature data.

At this point, the data indicating the start of the signature descriptor is written into the tag value 601, data indicating types of the hush function used to generate the digital signature data and the algorithm of the public key encryption are written into the kind of signature 603, the data length of the digital signature data s generated as described above is written into the signature data length, the data indicating the public key is written into the kind of key data 606, the public key Kp which corresponds to the private key Ks which was used to generate the digital signature data is written into the key data and the whole data length of the descriptor is written into the whole data length of descriptor 602 (see FIG. 6).

Here the data length of the IPMP descriptor changes as a result of inserting the signature descriptor into the IPMP descriptor, so the data written in the IPMP descriptor data length 502 is updated.

Next, at step 806 each of the data including the motion image data, the audio data, the still image data, the text data and the scene description information are encoded at their respective encoding units, and the procedure advances to step 807.

At step 807, the object data and descriptors generated as described above (including the IPMP descriptor) are multiplexed and the MPEG-4 stream is generated.

Next, at step 808 the MPEG-4 stream which has been generated as described above is transmitted to the reproducing apparatus by means of a transmission path, and then the processing ends. Here, the MPEG-4 stream may be copied to a storage medium such as a CD-ROM prior to the transmission.

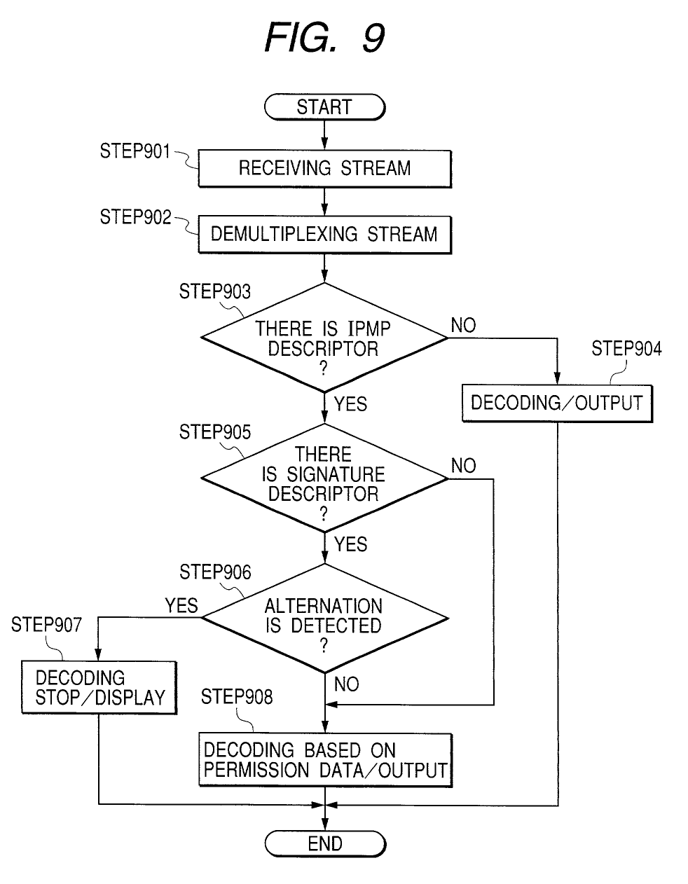

Hereinafter, explanation will be made using the flow chart in FIG. 9 of an operation of an apparatus of the present invention, and in particular one example of processing by the reproducing apparatus.

FIG. 9 is a flow chart for explaining a process of reproducing the MPEG-4 stream which has been generated by the above-mentioned transmission apparatus and has been received by the reproducing apparatus.

At step 901 in FIG. 9, the MPEG-4 stream generated by the transmission apparatus is received from the transmission path or from the CD-ROM or other storage medium.

Next, at step 902 the received MPEG-4 stream is demultiplexed into each of object data, such as the motion image data, the audio data, the still image data, the text data, the scene description information and the object descriptor, and then the process advances to step 903.

At step 903 a check is performed to ascertain whether or not an IPMP descriptor is present among the object descriptors which have been demultiplexed as described above. This check is performed by ascertaining whether or not the tag value which indicates that the IPMP descriptor is present among the object descriptors. In the case when the IPMP descriptor is present the process advances to step 905, and it the case when it is not present the process advances to step 904.

At step 904, since the IPMP system viewing/listening limitation has not been applied to any of object data, each of object data is decoded at corresponding decoder, and after that each is outputted to the output apparatus and the processing ends.

At step 905 a check is performed to ascertain whether or not the signature descriptor is present in the IPMP descriptor. This check is performed by ascertaining whether the tag value which indicates that the signature descriptor is present in the IPMP descriptor or not. In the case when the signature descriptor is present the procedure advances to step 906, and in the case when it is not present the procedure advances to step 908.

At step 906, the hush function and the algorithm of the public key encryption to be used for verification are identified using the data described in the kind of signature 603. Next, the data described in the signature data length 604 is used to extract the signature data s' which is described in the signature data 605. Next, the public key Kp to be used in the verification is extracted from the key data 607, and then the calculation using the public key Kp are performed on the signature data s' which was extracted as described above, to produce h′=E(Kp,s′). The public key encryption algorithm which is identified as described above is used for this calculation.

Additionally, the calculation using the hush function is performed on all of the data in the IPMP descriptor except the signature descriptor. That is, the calculation using the hush descriptor is performed on the tag value, the data length, the IPMP descriptor ID, the IPMP type and all of the approval information entire data D′, which are in the IPMP descriptor. The hush function which is identified as described above is used for these hush calculations, too.

Then a comparison is made between the h″=H(D′) resulting from the calculation using the above hush function and the h′ resulting from the calculation processing performed with the public key Kp on signature data. As a result of this comparison, in the case when the results from the two calculations match each other (i.e., h′=h″) then a determination is made that the IPMP descriptor has not been altered, and the process advances to step 908.

On the other hand, in the case when the above comparison reveals that the results from the two calculations do not match each other, then a determination is made that the IPMP descriptor has been altered in some manner, and the process advances to step 907.

At step 907, the alteration of the IPMP descriptor has been detected, so that the decoding procedure is not performed at all and a message indicating that the alteration has been detected is displayed on the screen, and the process ends.

At step 908, after the information described in the IPMP descriptor ID 503 is confirmed, a determination is made based on the data described in the IPMP type 504 as to whether the data described in the optional area 505 is real information or URL information, and after that, the data in the optional area 505 is extracted. According to the present embodiment, since the permission data is written in as real information by the transmission apparatus, after the permission data is extracted, the IPMP system performs the controls based on the permission data in the manner described above.

According to the present embodiment, it becomes possible to improve the functions of protecting/managing intellectual property rights (e.g., copyrights) on content in a multi-media coding system which has an intellectual property protection and management system. Therefore, it becomes possible to allow only a person who has a legitimate viewing/listening right (e.g., based on a copyright) to reproduce the content, and a holder of an intellectual property right (e.g., a copyright) on content may provide the content without anxiety, and thus, a content distribution service using a network becomes realistic.

Note that, it is possible to apply the present invention to a single apparatus (such as a copier, facsimile or mobile terminal like a portable telephone), or to a system which is comprised of a plurality of apparatuses (such as a host computer, an interface apparatus, a reader, and a printer).

Further, the scope of the present invention also covers that in order to operate each of the variety of apparatuses so as to realize the functions of the embodiment described above, a software program for realizing the embodiment is provided to a computer inside an apparatus or system connected to these various apparatuses and these various apparatuses are operated according to the program that has been stored in the computer (ex, CPU or MPU) of the system or apparatus.

Further, in this case, the software program itself realizes the above-mentioned functions of the embodiment of the present invention, and thus the program code itself and means for providing the program code to a computer, for example, which may be a storage medium storing the program code, also construct the present invention.

As a storage medium for storing the program code, for example, a floppy disk, a hard disk, an optical disk, an optical magnetic disk, a CD-ROM, a DVD-ROM, and a non-volatile memory card may be used.

Further, it goes without saying that the embodiment of the present invention is constructed by the program code not only in the case in which the computer realizes the above-described functions of the embodiment by executing the provided program code, but also in cases in which the program code works together with an OS (operating system) running on the computer or the software of another application to realize the above-mentioned functions of the embodiment, for example. Furthermore, it also goes without saying that it also constructs the embodiment of the present invention that the provided program code is stored in a memory provided to a function expansion board of a computer or a function expansion unit connected to the computer, and then a CPU or the like provided in the function expansion board or the function expansion unit carries out a part or all of the actual processes based on the instructions of the program code, and therefore, the above-mentioned functions of the embodiment are realized.

Further, the above-mentioned embodiment is explained for protection and management of intellectual property rights pertaining to the motion image data; however, the present invention is not limited to this, and the intellectual property rights protection and management may be performed according to a similar method for audio data, still image data or the like.

In other words, the foregoing description of embodiments has been given for illustrative purposes only and not to be construed as imposing any limitation in every respect.

The scope of the invention is, therefore, to be determined solely by the following claims and not limited by the text of the specifications and alterations made within a scope equivalent to the scope of the claims fall within the true spirit and scope of the invention.

What is claimed is:

1. A method for creating content in a multi-media encoding system provided with an intellectual property rights protection and management system, comprising the steps of:
generating intellectual property rights protection and management information containing verification data for verifying the authenticity of information in the content; and
burying the intellectual property rights protection and management information into the content in the form of a message used by the intellectual property rights protection and management system.

2. A method according to claim 1, wherein the verification data is data for verifying whether or not the information has been altered.

3. A method according to claim 2, wherein the verification data is data for verifying whether or not the intellectual property rights protection and management information has been altered.

4. A method according to claim 1, wherein the verification data at least includes code for indicating that the verification data begins, the data length of the verification data and real data for the verification.

5. A method according to claim 1, wherein the multi-media encoding system is an MPEG-4 encoding system, and the intellectual property rights protection and management information is an IPMP stream.

6. A method according to claim 1, wherein the multi-media encoding system is an encoding system, in which encoding is performed on an each object basis.

7. A method according to claim 6, wherein the object includes video information.

8. A method according to claim 7, wherein the object includes audio information.

9. A method according to claim 1, wherein the intellectual property rights protection and management system protects and manages copyrights of content.

10. A method according to claim 1, wherein the intellectual property rights protection and management system limits reproduction of the content.

11. A computer readable storage medium on which is recorded a program for executing the method for creating content according to claim 1.

12. An apparatus for creating content in a multi-media encoding system provided with an intellectual property rights protection and management system, comprising:
a) a generating device arranged to generate intellectual property rights protection and management information containing verification data for verifying the authenticity of information in the content; and
b) a multiplexer arranged to bury the intellectual property rights protection and management information into the content in the form of a message used by the intellectual property rights protection and management system.

13. A method for creating content in a multi-media encoding system provided with an intellectual property rights protection and management system, comprising the steps of:
inputting content in which there is buried intellectual property rights protection and management information containing verification data for verifying the authenticity of information in the content;
detecting the intellectual property rights protection and management information in the content; and
controlling reproducing operations of the content based on the results from said detection step.

14. A method according to claim 13, wherein the verification data is data for verifying whether or not the information in the content has been altered.

15. A method according to claim 14, wherein the verification data is data for verifying whether or not the intellectual property rights protection and management information has been altered.

16. A method according to claim 13, wherein the verification data at least includes code for indicating that the verification data begins, the data length of the verification data and real data for the verification.

17. A method according to claim 13, wherein the multi-media encoding system is an MPEG-4 encoding system, and the intellectual property rights protection and management information is an IPMP stream.

18. A method according to claim 13, wherein the multi-media encoding system is an encoding system, in which encoding is performed on an each object basis.

19. A method according to claim 18, wherein the object includes video information.

20. A method according to claim 19, wherein the object includes audio information.

21. A method according to claim 13, wherein the intellectual property rights protection and management system protects and manages copyrights of content.

22. A method according to claim 14, wherein at said detection step includes a step of detecting verification data to detect whether or not the content has been altered or not, and said controlling step includes a step of suppressing the reproduction operations in accordance with the results from said verification data detection step.

23. A computer readable storage medium which stores a program for executing the method for reproducing content according to claim 13.

24. An apparatus for creating content in a multi-media encoding system provided with an intellectual property rights protection and management system, comprising:
a) an inputting device arranged to input content in which there is buried intellectual property rights protection and management information containing verification data for verifying the authenticity of information in the content;
b) a detector arranged to detect the intellectual property rights protection and management information in the content; and
c) a controller arranged to control operations for reproducing the content based on the results from said detector.
